(19) United States
(12) Patent Application Publication
(10) Pub. No.: US 2018/0312159 A1
(43) Pub. Date: Nov. 1, 2018

(54) Utilization of alternators for recharging batteries and electric car mileage range improvement

(71) Applicant: Mark Leroy Anthony Jent, II, Whitesburg, KY (US)

(72) Inventor: Mark Leroy Anthony Jent, II, Whitesburg, KY (US)

(73) Assignee: Mark Jent, II, Whitesburg, KY (US)

(21) Appl. No.: 15/974,886

(22) Filed: May 9, 2018

Related U.S. Application Data
(60) Provisional application No. 62/603,689, filed on Jun. 9, 2017.

(51) Int. Cl. B60W 20/14; H02J 7/00; F03G 7/10; B60L 11/16; B60L 7/12; B60L 11/18

(52) U.S. Cl. CPC B60W 20/14; H02J 7/0072; B60L 11/1864; B60L 11/16; B60L 7/12; F03G 7/10

(57) ABSTRACT

This method covers the utilization of alternators for recharging batteries and electric car mileage range improvement. It involves the usage of the rotors to charge and to extend range for an electric car, while the car is in motion. There are two methods that will be explained, these methods are called the Jent methods. The first method will be connecting the alternator to the rear axles. The second method is having an alternator rotor hybrid so that the car can still charge and have the ability to stop and apply brakes with full function.

The first type of alternator came about in the 19^{th} century. In 1832, Hippolyte Pixii a French inventor was the first to construct an electric dynamo, an early version of an alternator. It did not stop there, there was many steps and many years until alternators became what they are today. In 1860, DC generator was created by Antonio Pacinotti. Seven years later, a Hungarian company started to commercialize alternators as AC generators from then on alternators became popular.

How alternators work is very important to understand. An alternator is basically a generator for a car. In today's time, an alternator is in every vehicle, giving charge to a vehicle's electrical systems. An alternator works when the engine is running, and the motor starts spinning the alternator by a pulley system called a drive belt. The alternator charges the battery and supplies electric power to the vehicle.

### RESEARCH

Alternators for years have been used for charging car batteries. When the car is started, the motor starts turning the alternator from a pulley system and thus the alternator begins to charge the battery. The Jent method utilizes alternators to collect the kinetic energy from the rotation of the vehicle's tires. The current product using kinetic energy to charge electric car batteries is regenerative braking, which collects kinetic energy by turning the motor backward when braking or letting off the gas.

The Jent method will work with regenerative braking to increase mile range but does not deal with perpetual motion. The Jent method is a range extender, with the ability to extend the range without making the batteries bigger, possibly allowing downsize of the batteries due to the effectiveness of the regenerative braking design and proposed method of using alternators to collect the spinning kinetic energy from the rotations of the tires.

Full electric cars do not run off the gas they run on the newly designed lithium batteries. The proposed method simply uses an alternator system which will increase the mileage and keep the battery charged much longer for EV's. An electric vehicle that has a high-voltage lithium-ion battery with a capacity of 33 kwh. The base Range (mi) for this project will be 124 miles.

The Jent method of alternators can be applied to electric vehicles, including cars, trucks, big rigs, trains; any form of transportation that has rotating wheels can utilize this method and collect kinetic energy from the turn of the wheels. Just like regenerative braking, it's already there just must utilize it.

The proposed method (the Jent method) of alternators will be economical because the range is extended. This method will have multiple ways it can be used, the first way is to use a pulley system on the axle on the rear tires. The second method is to have the alternators installed inside the tires, much like the concepts of the mini motors installed inside of tires. So instead of having mini motors making the tire spin, have an alternator inside a tire, so when the tire spins by an original motor setup, the alternator will be charging. Each tire can produce energy to the same level as a gas motor or more. When the vehicle drives down the road, the alternators will charge the car. This concept of an alternator using kinetic energy to give a constant charge to electric cars can be applied to mobile homes like RVs, trains, and big utility vehicles.

### How It Works

This method of alternators being used to extend mile range for electric cars will base off the original idea of how alternators charge the battery. Instead of using the motor to charge the battery, use the rotation of the tires to create kinetic energy. Using the kinetic energy from the tire rotation will increase the mileage range. This is not perpetual motion.

Once the alternator starts spinning, it will begin to send the collected energy to the battery to begin charging. All four alternators will be connected to one central wiring unit leading to the battery units. With one large lithium battery system, my alternator method will charge the battery while the car uses the battery. The battery will be connected to an input output system controlled by the vehicle's computer, that regulates the energy coming out and the energy coming in, so that the car can receive charge while running, just like an original gas motor vehicle and its alternator charging the battery.

Variables that need to be questioned: can the battery be overcharged? Once the battery is charged, what happens: do the alternators turn off? Does it overcharge the battery? The answer to these questions will be that the alternators will be connected to the battery through one joint wire harness, sending the energy to the battery and giving it a continuous charge, while the car is using the energy, making a theatrical flow of energy.

The alternator will continue to keep charging the car, because of the amount of energy a vehicle uses, from the inside technology that continues to run and then the mechanical exterior of vehicles. It will be a continuous charge from the alternators until the vehicle is parked. If the vehicle is already charged, the alternators will not turn on until the battery begins to lose charge.

### Alternator Cost

The alternators can be based of any brand of alternators that can be found in any local auto parts store. For the second method it will be a hybrid alternator rotor, that have not been calculated in price. Calculating how much energy the alternators will be gathering. The voltage and amperage of an alternator must be known. The type of alternator that is a suitable candidate for this is a common alternator from any parts store. A normal has 14 volts and 200 amps. (Voltage(volt) is a measure of electrical pressure, and Amperage (amp) is a measure of electrical current flow).

Nov with having 14 volts and 200 amps, take 14 and multiply by 200 which will equal 2,800 watts. Watts times hour will give kilowatts per hour(kwh). Then take 2,800 and multiply it by 1 hr which will equal 2.8 kwh. To know the total energy that the alternators are pulling is by taking 2.8 kWh and multiply by 4 because there are four tires that are rotating with four alternators. 2.8×4=11.2 kwh.

Having 11.2 kwh is a very good output, considering a standard total capacity of 33 kwh. This will keep the car constantly charging, and if the tires are moving, it will never lose charge. Giving the vehicle more gas or acceleration, will not help or hurt the charge of the vehicle, because it works from the rotations in a mile.

### How Much Will It Cost?

How much will all this cost? This is the big question. First, there is the cost of the vehicle, the cost of the alternators, the cost of the wire harness, and the manual labor cost. Using the basic electric car cost with a standard alternator and a MSRP of $42,400.

Second, will be the cost of the alternators. The alternator chosen for this calculation is a random price of the basic alternators which range for 100$ to 160$. The third is the cost of the wiring harness, called a BWD connector, will be $10 each. Four will cost $40 in total. The final cost will be the labor. The alternators will not be much more because if a vehicle manufacturer is producing it, it would be added in the total price of the vehicle and basically instead of buying one alternator for each vehicle they would need to buy five in total for every car, but the labor cost would stay the same.

### Project Management

This stage will be dealing with deciding which material will be the most proficient for cost and durability for the alternator mechanical pieces. The material that the alternator will need, will be the same as a normal alternator. That is the cheaper way to go about putting together the alternator. To make a more proficient one, it can be made of carbon fiber.

If the alternator is made of carbon fiber it can help with not weighing down the tire. A regular alternator can still be used for this project, but for better performance the alternator can be made of carbon fiber material. A standard alternator can be made from aluminum with steel for the windings. A standard alternator is very proficient, carbon fiber alternator would be stronger and lighter.

### Test/Evaluating

The testing stage involves designing and testing the alternator. Alternators will be gathering the kinetic energy from the rotor and then translate it to the battery. To understand how the alternator works, the voltage and amperage of an alternator must be known. (Voltage(volt) is a measure of electrical pressure, and Amperage (amp) is a measure of electrical current flow).

A basic alternator has 14 volts and 200 amps. To determine watts produced multiply volts by amps (14×200=2,800 watts). To determine kilowatts produced per hour (kwh) multiply Watts by kilowatt hours (2,800×0.001=2.8 kwh). To know the total energy created by the alternators multiply the kwh by as there are four tires rotating with four alternators (2.8×4=11.21 cwh).

Having 11.2 kwh is a very good output, hypothetical storage capacity for an electric vehicle can be 30 kwh to 40 kwh. A common household outlet supplies 200 watts per hour, so could take up to 7 hours for an electric car to charge. The proposed method will keep the car constantly charging when the tires are moving.

### Marketing Cost

This stage will consist of the economic finances of the build and design of the alternator. There are several factors that will be in play. First, is the cost of the alternator, is it economically affordable? Yes, it is, the alternators will be cheap to produce because there is already a market for them. The only difference being a company should order four extra alternators, giving five alternators in a total purchase for one car.

For this project, a standard electric car for any company generally runs in the ballpark of $42,000. The random alternator has a price range of $160. Four extra alternators will be required, which will cost $639.96 added to the MSRP. To cover the price of the alternator and make a profit, increase the MSRP above $42,639.96. For simply assume an additional $1,000 to the total price, resulting in an MSRP of $43,639.96.

Is this better than gas vehicles regular even vehicles? The alternator concept is better than a gas vehicle and even (electric vehicles), here are some reasons why. Reason 1, no more use of gas, and helping the electric vehicle market. Reason 2, the savings from cost of gas will pay for the cost of a vehicle. For example, if the consumer must purchase gas at $3 per gallon that would equal $36 if the consumer vehicle had a 12-gallon tank. lithe consumer should pay $36 a week it will average $144 in gas a month, making it $1,728 a year. By two years the total would be $3,456 if the gas stayed at $3 a gallon. By three years $5,184, four years it would be $6,912, five years would be $8,640 and six years would put the cost at $10,368. Over six years, the consumer could have used the $10,368 for the payments towards a vehicle with this new alternator concept.

The average cost of electricity in the US is 12 cents per kwh. Therefore, the average person driving the average 15,000 miles per year ends up paying $540.00 per year to charge. By using a fully electric car with this alternator concept, it eliminates the use of gas. Not having to pay for gas or having to stop by and use an electric pump will help the consumer save money and help save the earth.

### BRIEF DESCRIPTION OF THE DRAWINGS

FIG. 1: Rear axle connected with a casing for the alternator, every time the axle spins from the tire, it will be fitted with a pulley system that wraps around an alternator. With FIG. 1, there will be a casing that connects into the rear axle so that a chain can be fitted to the axle and around a alternator. The casing helps keep fluid inside ad keeps it a closed system.

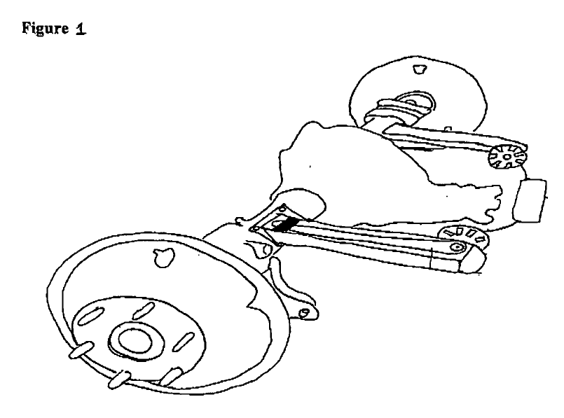

FIG. 2: Basic concept of how the alternators will charge, this next method is to have the alternator as a rotor for a wheel to be connected to. This way the alternator will not be in the way and the car can still stop easily.

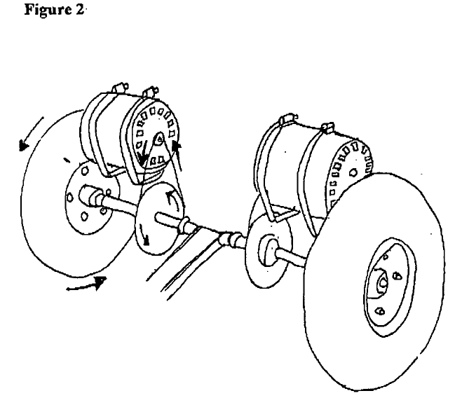

FIG. 3: hybrid alternator rotor will be very efficient in collecting each spin, while at the same time being able to stop the car when brakes are needed to be applied.

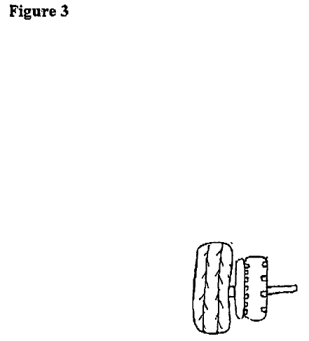

FIG. 4: hybrid alternator rotor wheel exploded view showing a longer extended view.

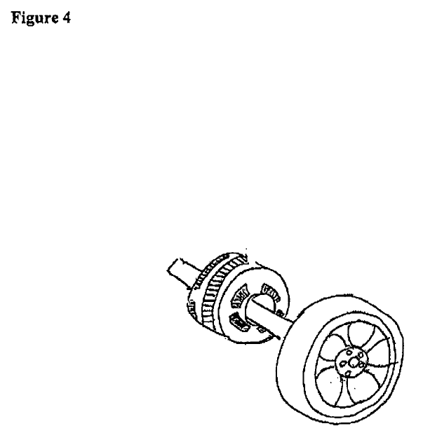

### The Benefit

With having the rotation of the tire giving charge to the vehicle, it will give the vehicle more power and help save energy cost. The consumer will save a lot of money compared to having a gas-powered vehicle. The convenience of having the alternators on electric cars will significantly increase the range of the vehicle. The range could go from 124 mi to 300 mi or more. Having to charge less will help save money.

Having alternators charging the car while driving is a great benefit for electric cars, it is cheap to install to the cars, and there is no reason to rebuild or redesign the car, the alternator design will simply just be attached. For long distance driving, this design would be very valuable. While on the highway, the car can be set on cruise control and use less energy, and while the tires turn, it will help keep the car charged longer. It eliminates having to pull over multiple times to charge the car.

1. A method comprising usage alternators to gather kinetic energy from tire rotation to boost extended mileage for electric vehicles.

2. A method according to claim 1, wherein the alternator will be connected to the axles.

3. A method according to claim 2, wherein there will be two alternators connected to the axles via a pulley system and belts.

4. A method according to claim 3, wherein the axle will have a two-inch opening allowing the belt line to wrap around the inner axle and connect back to the alternator.

5. A method according to claim 1, wherein the alternators will then be connected back to the two-battery system.

6. A method according to claim 5, wherein the two-battery system will be comprised of two lithium batteries and a dedicated computer to regulate energy input and output.

7. A method according to claim 6, wherein the computer will keep one battery running the vehicle, while battery two is being charged.

8. A method according to claim 7, wherein the first battery gets depleted and begins to charge.

9. A method according to claim 8, wherein the second battery will begin running the vehicle via computer.

10. A method according to claim 9, wherein the computer will be dedicated to running the battery charge during the vehicle traveling.

11. A method according to claim 1, wherein the alternators can be modified to conduct more kinetic energy with less rotation.

12. A method according to claim 11, wherein the alternators collects the kinetic energy for rotation via belts on a traditional motor, it can collect energy from the rotation of the tires.

13. A method according to claim 1, wherein the alternator will be connected to the axle, via pulley system, the alternator will be secured under the vehicle near the axle, the alternator will be secured safely by steel bolts to the frame.

14. A method according to claim 13, wherein the alternator will be connected. The system well be attached to the axle and have a cover encasing tie alternator to the axle, so that fluid will not escape the system.

15. A method according to claim 14, wherein the alternator will have a tensioner so that the pulley system will stay tight and not slip.

16. A method according to claim 1, wherein the alternator can also be an alternator rotor, as in the alternator will have a circler hole, so that the axle can go through to connect into the tire.

17. A method according to claim 16, wherein the alternator will be as a rotor as well, will have a brake caliper so that the vehicle can still have brakes.

18. A method according to claim 1, wherein the alternator will be connected to a two-system battery system with an attached computer program that will control the input and output of energy coming in.

19. A method according to claim 18, wherein their alternators will be connected to a two-system battery system, will increase mileage range.
